(19) United States
(12) Patent Application Publication
(10) Pub. No.: US 2020/0229439 A1
(43) Pub. Date: Jul. 23, 2020

(54) Storage Stable Biocide Composition

(71) Applicant: Thor GmbH, Speyer (DE)

(72) Inventor: Rüdiger Baum, Neulussheim (DE)

(73) Assignee: Thor GmbH, Speyer (DE)

(21) Appl. No.: 15/757,903

(22) PCT Filed: Aug. 29, 2016
(86) PCT No.: PCT/EP2016/001457

§ 371 Date: Mar. 6, 2018

(30) Foreign Application Priority Data
Sep. 9, 2015 (EP) 15002635.9

(51) Int. Cl. A01N 43/80; A01N 31/04; A01N 39/00

(52) U.S. Cl. CPC A01N 43/80; A01N 39/00; A01N 31/04

(57) ABSTRACT

The present invention relates to a storage stable biocide composition containing the following components: (a) from 2 wt % to 20 wt % of one or more isothiazolinones selected from the group consisting of methylisothiazolin-3-one (MIT), 1,2-benzisothiazolin-3-one (BIT), and N-methyl-1,2-benzisothiazolin-3-one (M-BIT), (b) from 65 wt % to 97 wt % of at least one biocide selected from the following group: phenoxyethanol, phenetyl alcohol, and phenylpropanol, and (c) from 1 wt % to 15 wt % of water. The invention furthermore relates to use of the composition in order to protect technical materials from spoilage and/or degradation as a result of microorganisms.

The present invention relates to a storage stable biocide composition containing the following components: (a) from 2 wt % to 20 wt % of one or more isothiazolinones selected from the group consisting of methylisothiazolin-3-one (MIT), 1,2-benzisothiazolin-3-one (BIT), and N-methyl-1,2-benzisothiazolin-3-one (M-BIT), (b) 65 wt %-97 wt % of at least one biocide selected from the following group: phenoxyethanol, phenetyl alcohol, and phenylpropanol, and (c) from 1 wt % to 15 wt % of water. The invention furthermore relates to use of the composition in order to protect technical materials from spoilage and/or degradation as a result of microorganisms.

Mixtures of 1,2-benzisothiazolin-3-one, hereinafter also referred to as BIT, and methylisothiazolin-3-one, hereinafter also referred to as MIT, are known, for example, from the international WO 99/08530 A1 application. As a result of their bactericidal and fungicidal properties, these mixtures are often used in technology as a biocide in order to protect against microbial spoilage in aqueous media and technical products containing water.

Since biocide compositions that contain MIT and BIT are usually added in concentrate form to the media or technical products being protected, it is desirable for the compositions to be available in the form of concentrated, fluid compositions which are also stable in storage.

Within the context of the stability of isothiazolinone concentrates, the European specification published as EP 0 450 916 A1 recommends isothiazolinone compositions whose isothiazolinone content preferably comprises 5-chloro-2-methyl-3-isothiazolone, 2-methyl-3-isothiazolone, 2-octyl-3-isothiazolone, 4,5-dichloro-2-cyclohexyl-3-isothiazolone, and 4,5-dichloro-2-octyl-3-isothiazolone, and said compositions are stabilized by means of a phenoxyethanol, preferably phenoxyethanol. The compositions specified in EP 0 450 916 A1 preferably contain less than 5 wt % of water, and the compositions quite particularly preferably contain no water. As regards storage stability, however, the compositions exhibit the disadvantage of forming condensation and precipitates in cold weather conditions, in particular at low temperatures such as colder than 5° C. and/or in temperature conditions involving freezing and thawing, thus representing a serious handling problem.

Based on the prior art, therefore, the object of the invention is to provide flowable biocide compositions having storage stability and containing methylisothiazolin-3-one (MIT) and 1,2-benzisothiazolin-3-one (BIT).

This object will be achieved by means of a storage stable biocide composition comprising the following components:
(a) from 2 wt % to 20 wt % of one or more isothiazolinones selected from the group consisting of methylisothiazolin-3-one (MIT), 1,2-benzisothiazolin-3-one (BIT), and N-methyl-1,2-benzisothiazolin-3-one (M-BIT),
(b) from 65 wt % to 97 wt % of at least one biocide selected from the following group: phenoxyethanol, phenetyl alcohol, and phenylpropanol, and
(c) from 1 wt % to 15 wt % of water,
   or rather consists of the components (a), (b), and (c). The composition in the present invention is characterized by a broad spectrum of action and exhibits storage stability at temperatures less than 5° C., thus surpassing the results previously achieved by other biocide compositions. In a preferential embodiment of the present invention, the antimicrobial composition described herein is storage stable at temperatures of less than 5° C.

According to a further embodiment of the invention, the biocide composition comprises, as an additional component, component (d): from 0.1 wt % to 10 wt % of one or more glycols selected from the group consisting of monoethylene glycol, diethylene glycol, triethylene glycol, propylene glycol, tripropylene glycol, dipropylene glycol, and mono-, di-, tri, and tetra-polyethylene glycol as well as methyl and butyl ethers thereof. The presence of the (d) component(s) thus leads to an even greater improvement in the stability of the compositions according to invention.

The biocide composition preferably contains the following components, or rather consists of the following components:
(a) from 2 wt % to 20 wt % of one or more isothiazolinones selected from the group consisting of methylisothiazolin-3-one (MIT), 1,2-benzisothiazolin-3-one (BIT), and N-methyl-1,2-benzisothiazolin-3-one (M-BIT),
(b) from 65 wt % to 97 wt % of at least one biocide selected from the following group: phenoxyethanol, phenetyl alcohol, and phenylpropanol, and
(c) from 1 wt % to 15 wt % of water, and
(d) from 0.1 wt % to 10 wt % of one or more glycols selected from the group consisting of monoethylene glycol, diethylene glycol, triethylene glycol, propylene glycol, tripropylene glycol, dipropylene glycol, and mono-, di-, tri, and tetra-polyethylene glycol as well as methyl and butyl ethers thereof.

According to a preferential embodiment of the invention, the biocide composition contains, as component (d), diethylene glycol and/or triethylene glycol. According to a particularly preferential embodiment of the invention, the biocide composition contains, as component (d), diethylene glycol in a quantity-based on the biocide composition—of from 1 wt % to 5 wt %, preferably in a quantity from 1.5 wt % to 3 wt %.

The biocide composition contains, as component (a), generally from 2 wt % to 20 wt %, preferably from 2 wt % to 10 wt %, and particularly preferably from 4 wt % to 8 wt % of one or more isothiazolinones selected from the group consisting of methylisothiazolin-3-one (MIT), 1,2-benzisothiazolin-3-one (BIT), and N-methyl-1,2-benzisothiazolin-3-one (M-BIT).

According to a preferential embodiment of the invention, the biocide composition contains, as component (a), from 2 wt % to 20 wt %, preferably from 2 wt % to 10 wt %, and particularly preferably from 4 wt % to 8 wt % methylisothiazolin-3-one and 1,2-benzisothiazolin-3-one. According to an even more preferential embodiment of the invention, the biocide composition contains only methylisothiazolin-3-one and 1,2-benzisothiazolin-3-one as isothiazolinones. The weight ratio between methylisothiazolin-3-one and 1,2-benzisothiazolin-3-one can be varied within a broad range, but the weight ratio between methylisothiazolin-3-one and 1,2-benzisothiazolin-3-one preferably measures from 1:10 to 10:1, more preferably from 1:5 to 5:1, and particularly preferably from 1:3 to 3:1.

According to a preferential embodiment of the invention, the biocide composition contains, as component (a), from 2 wt % to 20 wt %, preferably from 2 wt % to 10 wt %, and particularly preferably from 4 wt % to 8 wt % methylisothiazolin-3-one and N-methyl-1,2-benzisothiazolin-3-one. According to an even more preferential embodiment of the invention, the biocide composition contains only methylisothiazolin-3-one and N-methyl-1,2-benzisothiazolin-3-one as isothiazolinones. The weight ratio between methylisothiazolin-3-one and N-methyl-1,2-benzisothiazolin-3-one can be varied within a broad range, but the weight ratio between methylisothiazolin-3-one and N-methyl-1,2-benzisothiazolin-3-one preferably measures from 1:10 to 10:1, more preferably from 1:5 to 5:1, and particularly preferably from 1:3 to 3:1. The microbiocidal active components (a) using isothiazolin-3-one are known substances and are as such commercially available or able to be produced according to known methods.

The biocide composition according to the invention contains, as component (b), generally from 65 wt % to 97 wt %, preferably from 75 wt % to 97 wt %, and particularly preferably from 80 wt % to 90 wt % of at least one biocide selected from the following group: phenoxyethanol, phenetyl alcohol, and phenylpropanol. In the context of the present invention, “at least one biocide selected from the group” means that the biocide composition according to the invention contains one biocide or two biocides or three biocides selected from the following group: phenoxyethanol, phenetyl alcohol, and phenylpropanol. According to a preferential embodiment of the invention, the biocide composition according to the invention contains generally from 65 wt % to 97 wt %, preferably from 75 wt % to 97 wt %, and particularly preferably from 80 wt % to 90 wt % of phenoxyethanol.

As component (c), the biocide composition according to the invention contains generally from 1 wt % to 15 wt %, preferably from 5 wt % to 10 wt %, more preferably from 5.5 wt % to 10 wt %, and particularly preferably from 7.5 wt % to 10 wt % of water. In contrast to the teaching in the EP 0 450 916 A1 document, according to which isothiazolinone concentrates that are stabilized with phenoxyethanol should contain less than 5 wt % of or, preferably, no water, it has been shown in the context of this invention that the precise proportion of water defined above is crucial in regard to the storage stability of the compositions according to the invention.

According to a particularly preferential embodiment of the invention, the biocide composition contains the following components, or rather consists of the following components:

(aa) 2 wt % of methylisothiazolin-3-one,
(ab) 2 wt % of 1,2-benzisothiazolin-3-one,
(b) 87 wt % of phenoxyethanol, and
(c) 9 wt % of water.

According to a further particularly preferential embodiment of the invention, the biocide composition contains the following components, or rather consists of the following components:

(aa) 2 wt % of methylisothiazolin-3-one,
(ab) 2 wt % of 1,2-benzisothiazolin-3-one,
(b) 80 wt % of phenoxyethanol,
(c) 14 wt % of water, and
(d) 2 wt % of diethylene glycol.

The biocide compositions generally exhibit a pH level of from 4 to 7 under standard conditions, and preferably a pH level of from 5 to 6.

The biocide compositions according to invention are fluid. In the context of the invention, the term “fluid” means that the biocide composition exists in a fluid physical state at room temperature, preferably at temperatures up to 0° C., and the proportion of solid components measures from 0 to 1 wt %, preferably from 0 to 0.5 wt %. It is particularly preferable for the biocide compositions to contain no solid components.

In general, it is possible to adapt the biocide composition to specific fields of application through the addition of further active substances, for example in terms of an enhanced action or improved compatibility with the substances being protected from microorganisms. These further active substances are known to a skilled person in the biocide field and can be selected by the skilled person depending on the application of the biocide composition according to the invention.

In a particularly preferential embodiment of the invention, the biocide composition according to the invention contains no further biocides in addition to the isothiazolinones and the phenoxyethanol.

The biocide composition according to the invention is particularly suitable for the preservation of technical materials which are susceptible to spoilage as a result of microorganisms.

The invention furthermore relates to use of the biocide composition according to the invention in order to protect technical materials from spoilage as a result of microorganisms and to combat microorganisms as well as a method for protecting technical materials from spoilage and/or degradation as a result of microorganisms, the method being characterized in that the biocide composition according to the invention is allowed to act on the microorganism or the habitat thereof. Said action can in this case take place in a diluted or an undiluted form. In terms of the invention, microorganisms are, for example, bacteria, filamentous fungi, and yeasts.

The invention additionally relates to the technical materials which are obtainable by way of technical materials being treated using the biocidal composition according to the invention. Preferred technical materials include technical products containing water such as detergents, cleaners, lignosulfonates and starch preparations, as well as coating agents such as paints, varnishes and glazes, as well as in renders, emulsions, latices, polymer dispersions, chalk slurries, mineral slurries, ceramic masses, adhesives, sealants, fragrances, products containing casein, products containing starch, bitumen emulsions, surfactant solutions, motor fuels, cleaning agents, pigment pastes and pigment dispersions, inks, lithographic fluids, thickeners, cosmetic products, toiletries, water circuits, liquids used in paper processing, liquids used in wood processing, liquids used in petroleum extraction, liquids used in leather production, drilling and cutting oils, hydraulic fluids, and cooling lubricants.

It is particularly preferable for the biocide composition according to the invention to be used in order to preserve technical materials such as detergents, cleaners, and cooling lubricants.

The applied concentration of the biocide composition will depend on the nature and abundance of the microorganisms being combated, the initial microbial load, as well as the composition of the technical material being protected. The optimum quantity to be used for a specific application can easily be determined by laboratory test series in a manner sufficiently familiar to the skilled person before the composition is employed in practice.

In general, the applied concentrations of the biocide composition according to the invention are—based on the technical material being protected—in the range of from 0.01 wt % to 5 wt %, preferably in the range of from 0.05 wt % to 1.0 wt %, and particularly preferably in the range from 0.1 wt % to 0.5 wt % of the biocide composition according to the invention.

### THE FOLLOWING EXAMPLES WILL SERVE TO FURTHER CLARIFY THE PRESENT INVENTION

### Investigation of the Storage Stability of Biocide Compositions Having Varying Water Content

In order to investigate the storage stability of biocide compositions having an isothiazolinone content of from 5 to 6 wt % as well as containing phenoxyethanol, the biocide compositions described in the following Tables were produced using a varying water content and stored for a period of 24 hours at 0° C. or 5° C.

As can be gathered from Tables 1 to 3, shown hereinafter, storage stable compositions are able to be obtained at lower temperatures only given a water content of between 3 wt % and 7.5 wt %.

TABLE 1

| Test: 24 hours at 5° C. | Water content [wt %] | | | | | | |
|---|---|---|---|---|---|---|---|
| Concentrations [wt %] | 0 | 1 | 2 | 3 | 5 | 7.5 | 10 |
| 5 MIT in PE | − | − | 0 | + | + | + | + |
| 5 BIT in PE | − | − | − | + | + | + | + |
| 2.5 MIT + 2.5 BIT in PE | − | − | 0 | + | + | + | + |
| 4 MIT + 2 BIT in PE | − | 0 | 0 | + | + | + | + |
| 2 MIT + 4 BIT in PE | − | − | − | − | 0 | + | + |

MIT: Methylisothiazolin-3-one;
BIT: 1,2-benzisothiazolin-3-one,
PE: Phenoxyethanol
“0” = nearly dissolved;
“−” = frozen;
“+” = clear, dissolved

TABLE 2

| Test: 24 hours at 0° C. | Water content [wt %] | | | | | | |
|---|---|---|---|---|---|---|---|
| Concentrations [wt %] | 0 | 1 | 2 | 3 | 5 | 7.5 | 10 |
| 5 MIT in PE | − | − | − | − | − | + | + |
| 5 BIT in PE | − | − | − | − | − | + | + |
| 2.5 MIT + 2.5 BIT in PE | − | − | − | − | − | + | + |
| 4 MIT + 2 BIT in PE | − | − | − | − | 0 | + | + |
| 2 MIT + 4 BIT in PE | − | − | − | − | 0 | + | + |

MIT: Methylisothiazolin-3-one;
BIT: 1,2-benzisothiazolin-3-one,
PE: Phenoxyethanol
“0” = nearly dissolved;
“−” = frozen;
“+” = clear, dissolved

TABLE 3

| Test: 24 hours at −5° C. | Water content [wt %] | | |
|---|---|---|---|
| Concentrations [wt %] | 3 | 5 | 7.5 |
| 10 MIT + 2.5 M-BIT in PE | 0 | 0 | 0 |
| 10 MIT + 2.5 M-BIT in PE | 0 | 0 | + |

MIT: Methylisothiazolin-3-one;
M-BIT: N-methyl-1,2-benzisothiazolin-3-one,
PE: Phenoxyethanol;
“0” = nearly dissolved;
“−” = frozen;
“+” = clear, dissolved

### Investigation of the Storage Stability of Biocide Compositions Furthermore Containing Component (d), the at Least One Glycol:

In order to investigate the storage stability of biocide compositions furthermore containing at least one glycol, component (d), in addition to components (a), (b), and (c), the biocide compositions described in Table 4 hereinafter were produced and stored for a period of 24 hours at −5° C.

As can be gathered from Table 4, shown hereinafter, the biocide compositions are storage stable at −5° C.

TABLE 4

| Test: 24 hours at −5° C. | |
|---|---|
| Concentrations [wt %] | Assessment |
| 10 Water + 2 MIT + 2 BIT + 86 PE + 2 PEG 200 | + |
| 10 Water + 2 MIT + 2 BIT + 96 PE + 2 Monoethylene | + |
| glycol | |
| 10 Water + 2 MIT + 2 BIT + 96 PE + 2 Diethylene glycol | + |
| 10 Water + 2 MIT + 2 BIT + 96 PE + 2 Triethylene glycol | + |

MIT: Methylisothiazolin-3-one;
BIT: 1,2-benzisothiazolin-3-one,
PE: Phenoxyethanol
“0” = nearly dissolved;
“−” = frozen;
“+” = clear, dissolved

1. A biocide composition containing the following components:
(a) from 2 wt % to 20 wt % of one or more isothiazolinones selected from the group consisting of methylisothiazolin-3-one (MIT), 1,2-benzisothiazolin-3-one (BIT), and N-methyl-1,2-benzisothiazolin-3-one (M-BIT),
(b) from 65 wt % to 97 wt % of at least one biocide selected from the following group: phenoxyethanol, phenetyl alcohol, and phenylpropanol, and
(c) from 1 wt % to 15 wt % of water.

2. The biocide composition according to claim 1, characterized in that said composition contains phenoxyethanol as component (b).

3. The biocide composition according to claim 1, characterized in that said composition furthermore contains, as component
(d) from 0.1 wt % to 10 wt % of one or more glycols selected from the group consisting of monoethylene glycol, diethylene glycol, triethylene glycol, propylene glycol, tripropylene glycol, dipropylene glycol, and mono-, di-, tri, and tetra-polyethylene glycol as well as methyl and butyl ethers thereof.

4. The biocide composition according to claim 3, characterized in that said composition contains diethylene glycol as component (d).

5. The biocide composition according to claim 1, characterized in that said composition contains only methylisothiazolin-3-one (MIT) and 1,2-benzisothiazolin-3-one (BIT) as isothiazolinones.

6. The biocide composition according to claim 1, characterized in that said composition contains only methylisothiazolin-3-one (MIT) and N-methyl-1,2-benzisothiazolin-3-one (M-BIT) as isothiazolinones.

7. The biocide composition according to claim 1, characterized in that said composition contains, as component (c), from 5 wt % to 10 wt % of water.

8. The biocide composition according to claim 1, characterized in that said composition contains the methylisothiazolin-3-one (MIT) and the 1,2-benzisothiazolin-3-one (BIT) at a ratio of from 1:3 to 3:1.

9. The biocide composition according to claim 1, characterized in that said composition consists of the following components:
(aa) 2 wt % of methylisothiazolin-3-one,
(ab) 2 wt % of 1,2-benzisothiazolin-3-one,
(b) 87 wt % of phenoxyethanol, and
(c) 9 wt % of water.

10. The biocide composition according to claim 1, characterized in that said composition consists of the following components:
(aa) 2 wt % of methylisothiazolin-3-one,
(ab) 2 wt % of 1,2-benzisothiazolin-3-one,
(b) 80 wt % of phenoxyethanol,
(c) 14 wt % of water, and
(d) 2 wt % of diethylene glycol.

11. The use of a biocide composition according to claim 1 in order to protect technical materials from spoilage by means of combating microorganisms in a non-therapeutic manner.

12. A method for protecting technical materials from spoilage, degradation or both spoilage and degradation as a result of microorganisms, the method being characterized in that the biocide composition according to claim 1 is allowed to act on the microorganism or the habitat thereof.

13. The technical materials which are obtainable by way of technical materials being treated using a biocidal composition according to claim 1.

14. The biocide composition according to claim 1, characterized in that said composition contains, as component (c), from 7.5 wt % to 10 wt % water.
